(19) United States
(12) Patent Application Publication
(10) Pub. No.: US 2014/0232122 A1
(43) Pub. Date: Aug. 21, 2014

(54) ACTUATING DEVICE AND METHOD FOR ACTUATING A CLOSING DEVICE OF A VEHICLE

(71) Applicant: BROSE SCHLIESSSYSTEME GMBH & CO. KG, Wuppertal (DE)

(72) Inventors: Sebastian Schnetter, Reckendorf (DE); Rolf Bucker, Bamberg (DE)

(73) Assignee: BROSE ACHLIESSSYSTEME GMBH & CO. KG, Wuppertal (DE)

(21) Appl. No.: 14/348,021

(22) PCT Filed: Oct. 29, 2012
(86) PCT No.: PCT/EP2012/004515

§ 371 Date: Mar. 27, 2014

(30) Foreign Application Priority Data
Oct. 31, 2011 (DE) 10 2011 085 510.6

(51) Int. Cl. E05C 3/16

(52) U.S. Cl. CPC E05C 3/16
USPC 292/336.3

(57) ABSTRACT

An actuating device for actuating a closing device of a vehicle is provided. The actuating device comprises an adjustable handle part, an actuating element coupled with the handle part, which is movable by adjusting the handle part for actuating the closing device, and a securing device operatively connected with the actuating element which includes a mass element and a locking means, wherein the mass element is arranged at a transmission means connected with the actuating element, which is moved when adjusting the handle part together with the actuating element. In a normal operating state during a movement of the actuating element the mass element and the locking means are movable relative to each other along an adjusting direction. In an exceptionally loaded state, in which the mass element and the locking means are shifted relative to each other in a direction transversely to the adjusting direction, a relative movement of the mass element and the locking means along the adjusting direction is blocked such that the actuating element is not movable for actuating the closing device.

### CROSS-REFERENCE TO A RELATED APPLICATION

This application is a National Phase Patent Application of International Patent Application Number PCT/EP2012/004515, filed on Oct. 29, 2012, which claims priority of German Patent Application Number 10 2011 085 510.6, filed on Oct. 31, 2011.

### BACKGROUND

This invention relates to an actuating device for actuating a closing device of a vehicle and to a method for actuating a closing device of a vehicle.

Such actuating device, realized for example by an outside door handle of a vehicle door, includes an adjustable handle part and an actuating element coupled with the handle part. The actuating element is movable by adjusting the handle part for actuating the closing device, for example a door lock of a vehicle door, such that by adjusting the handle part via the actuating element an actuating force can be transmitted to the closing device via a suitable transmission means, for example in the form of a Bowden cable or a linkage, and the closing device thus can be actuated.

For door lock arrangements in vehicle doors it is required in principle that in the case of a crash the vehicle door must not be unlocked, because an opening of a vehicle door for example in the case of a car turning over might lead to a vehicle occupant being hurled out and thus might contribute to a considerable increase of the risk of injury.

A possible cause for an opening of a vehicle door as a result of an undesired lock actuation can consist in that in the case of a crash the door handle is—inadvertently—adjusting and the door lock arrangement is unlocked. Therefore, it is required in principle to largely minimize the risk for an unwanted actuation of a door handle in the case of a crash.

In the case of a crash—in particular during a side crash on a vehicle side door—forces of inertia act on the door handle, which possibly also act in an opening direction in which the door handle is to be adjusting for actuating the door lock. To avoid an inertia-related actuation of the door handle in such a crash, compensating mass elements conventionally are provided, which compensate forces of inertia acting in direction of an opening direction of the door handle and thus prevent that the door handle can be actuated due to forces of inertia acting in the opening direction.

When a single compensating mass element is provided, the same in particular acts against those forces of inertia which are directed exactly along the opening direction of the door handle, along which the door handle is to be moved for actuating the door lock. Such compensating mass element thus in particular reliably acts in the case of a crash in which a vehicle is hit from a lateral impact direction.

To be able to additionally also absorb forces of inertia which occur during an impact which does not occur exactly laterally, it is also possible to use a plurality of compensating mass elements which are arranged at an angle to each other and thus can effect a compensation with respect to forces of inertia in different directions. Such arrangements however have the disadvantage that they require an increased amount of installation space and also increase the weight of the actuating device.

In any case, compensating mass elements require a fine adjustment, in order to be able to ensure a sufficient crash safety.

Proceeding therefrom, there is a demand for securing devices which in crash cases of any type are able to safely and reliably prevent an actuation of a handle part of an actuating device, in order to inhibit for example an opening of a vehicle door due to the acting crash forces in the case of a crash.

### SUMMARY

It is an object of the present invention to provide an actuating device and a method for actuating a closing device, which are able to reliably prevent an unwanted actuation in the case of a crash.

According to an exemplary embodiment of the invention, in an actuating device there is provided a securing device operatively connected with the actuating element, which includes a mass element and a locking means, wherein the mass element is arranged at a transmission means connected with the actuating element, which on adjusting the handle part is moved together with the actuating element, and
in a normal operating state during a movement of the actuating element the mass element and the locking means are movable relative to each other along an adjusting direction, and
in an exceptionally loaded state, in which the mass element and the locking means are shifted relative to each other in a direction transverse to the adjusting direction, a relative movement of the mass element and the locking means along the adjusting direction is blocked such that the actuating element is not movable for actuating the closing device.

The present invention proceeds from the idea to use an additional securing device for an actuating device, which includes a mass element and a locking means which are movable relative to each other by the action of crash forces. The mass element and the locking means cooperate such that in a normal operating state with a proper use of the actuating device a relative movement of the mass element and of the locking means in an adjusting direction is easily possible. In the case of a crash, the mass element and the locking means however are shifted against each other transversely to the adjusting direction due to acting crash or inertial forces, so that the mass element and the locking means cannot (no longer) be adjusted relative to each other in the adjusting direction and the closing device cannot be actuated inadvertently.

In the case of a normal actuation of the actuating device in the normal operating state, the mass element and the locking means are moved along the adjusting direction (which preferably is different from the opening direction of the handle part of the actuating device), when the actuating element is shifted as a result of an actuation of the handle part. In the exceptionally loaded state, i.e. in the case of a crash, however a deflection and possibly vibration of the mass element relative to the locking means occurs transversely to this adjusting direction, so that due to this displacement the relative movement of the mass element and the locking means is blocked.

The use of such mass element in cooperation with a locking means has the advantage that in the case of a crash a deflection of the mass element relative to the locking means can be effected in all directions transversely to the adjusting direction, along which the mass element is moved relative to the locking means in the normal operating state. By deflection in any direction transversely to the adjusting direction, crash and inertial forces acting in the case of a crash thus can be absorbed, wherein with each deflection of the mass element as a result of a crash or inertial force, which does not act exactly along the adjusting direction, blocking of the relative movement of mass element to locking element is effected and hence an actuation of the actuating element is blocked.

At this point it should be noted that a deflection in the case of a crash regularly is effected dynamically, and the mass element and/or the securing device also can be put into vibrations as a result of a pulse-like crash load, which vibrations lead to a deflection and therefore to a blocking of the securing device.

The adjusting direction along which the mass element and the locking means can be moved relative to each other when the actuating element is adjusting preferably is different from the opening direction in which the handle part is moved during a normal actuation. The adjusting direction for example can be directed along the power flow direction in which the actuating forces are transmitted from the actuating element of the actuating device towards a closing device.

The actuating device advantageously includes a bearing bracket at which the handle part and the actuating element are arranged and by means of which a compact construction unit to be mounted in a modular fashion is created. The securing device likewise can be arranged at the bearing bracket or also at the closing device or at another component in the power transmission train between the actuating device and the closing device, for example in a Bowden system transmitting forces.

The mass element is arranged at a transmission means connected with the actuating element, e.g. with a pulling means in the form of a cable exclusively transmitting pulling forces or with a rigid coupling linkage.

Due to the fact that the mass element is arranged at a transmission means connected directly with the actuating element, which on adjusting the handle part is moved together with the actuating element, it is ensured that a movement of the actuating element is blocked before it occurs. Due to the fact that the transmission means directly is operatively connected with the actuating element, a movement of the actuating element is accompanied by a movement of the mass element, which is blocked, however, in the case of a crash.

The transmission means for example can extend between the actuating element and a stationary portion, at which the actuating element is movably arranged, and can resiliently be held at the stationary portion. Alternatively, it is also possible to arrange the mass element at a transmission means which is used for transmitting the actuating force from the actuating element towards the closing device and extends between the actuating element and the closing device. In the first case, an additional transmission means is used, which is mounted between the actuating element and the stationary portion, for example the bearing bracket, and carries the mass element. In the second case, the transmission means present anyway is used, which extends between the actuating element and the closing device for transmitting actuating forces, so that no additional cable or the like must be introduced.

Due to the fact that the mass element is arranged at a transmission means extending between the actuating element and the stationary portion or between the actuating element and the closing device, the mass element can be deflected transversely to the direction of extension of the transmission means, which corresponds to the adjusting direction of the mass element relative to the locking means in the case of a normal actuation of the actuating device. In a normal operating state, the mass element and the locking means are not deflected and during an actuation of the actuating element thus can be moved relative to each other in the adjusting direction, e.g. by pulling the transmission means. When crash forces are acting in the case of a crash, the mass element on the other hand is deflected transversely to the adjusting direction, i.e. transversely to the direction of extension of the transmission means, relative to the locking means, so that a relative movement between the mass element and the locking means is blocked in the adjusting direction.

The locking means in particular can form an opening which in the normal operating state is arranged relative to the mass element such that the mass element can be moved through the opening, in order to adjust the mass element and the locking means relative to each other along the adjusting direction. In the exceptionally loaded state, in which the mass element is deflected relative to the locking means transversely to the adjusting direction, the mass element on the other hand cannot be moved through the opening, so that a relative movement between the mass element and the locking means is blocked and correspondingly the actuating element cannot be adjusted for actuating the closing device.

In a first concrete configuration, the opening of the locking means can be formed at a vibrating body of the locking means, wherein the vibrating body for example can be arranged at the bearing bracket so as to be pivotable in a plane transverse to the adjusting direction, e.g. via an axle element. In the case of a crash, the mass element on the one hand and the vibrating body on the other hand thus can be moved due to the acting inertial and crash forces, wherein the deflection of the mass element on the one hand and of the vibrating body on the other hand is different and thus, in the deflected condition of the mass element and/or the vibrating body, the mass element cannot be adjusted along the adjusting direction relative to the vibrating body, and thus a relative movement of mass element and vibrating body is blocked along the adjusting direction.

To ensure that in the normal operating state the opening of the vibrating body is in alignment with the mass element, and in the normal operating state the mass element thus can be moved through the opening of the vibrating body, for example a spring element can be provided, which biases the vibrating body into a rest position, so that in the normal operating state the vibrating body is held in the rest position. As a result of a load, the vibrating body then can be deflected from the rest position and in this case pivots in a swivel direction transversely to the adjusting direction, along which the mass element and the locking means can be adjusted relative to each other in the normal operating state.

When the locking means includes a vibrating body, the same as compared to the mass element advantageously is formed and mounted such that in the exceptionally loaded state the vibrating body and the mass element are deflected differently, so that a relative movement of the mass element and the vibrating body along the adjusting direction is blocked. The deflection and the vibrating movement of the mass element and the vibrating body in the case of a crash thus are different, so that it is excluded that the opening at the vibrating body and the mass element are in alignment in the case of a crash, and thus it is ensured that the locking device blocks in the case of a crash.

For example, the vibrating body and the mass element can have different masses, wherein it is also conceivable alternatively or in addition to adjust a (spring) bias in the bearing of the vibrating body and the mass element such that a different deflection is ensured in the case of a crash.

In an advantageous configuration, the locking means can include a housing at which the vibrating body forming the opening is held. In this case, the opening thus is not formed by the housing itself, but by a vibrating body held at the housing, which is arranged at the housing such that the vibrating body can be deflected in a plane transverse to the adjusting direction. This can be achieved in that the vibrating body is held at the housing via at least one spring element, preferably via at least three spring elements, and thus is elastically supported on the housing in a plane transverse to the adjusting direction.

As an alternative to the use of spring elements for holding the vibrating body at the housing, there can also be used one or more molded parts which rigidly hold the vibrating body at the housing in a plane transverse to the adjusting direction.

These molded parts can be integrally molded to the walls of the housing and connect the vibrating body with the housing, wherein the molded parts each can have a predetermined breaking point which is designed such that by breaking the molded parts—for example as a result of acting crash forces—the vibrating body is detached from the housing, is (at least slightly) radially movable, and is then axially held via suitable axial securing elements.

The use of such molded parts provides for the fabrication of the housing and the vibrating body in an integral construction in a single operation and mold for example by means of plastics injection molding.

As an alternative to the integral construction, the molded parts also can be attached to the walls of the housing via releasable clip connections, wherein the required force for releasing each clip connection can be adjusted such that in operation an unintentional release is not possible and in particular crash forces can be absorbed in the case of a crash, but by applying a sufficiently large force exceeding the threshold value, the vibrating body can be removed from the housing.

In all variants in which a vibrating body is rigidly or elastically held at the housing in a plane transverse to the adjusting direction, one or more axial securing elements additionally can be arranged at the housing, which also support the vibrating body against a displacement along the adjusting direction relative to the housing and thus axially fix the vibrating body at the housing. These axial securing elements for example can be formed as protrusions which axially rest against the vibrating body and thus axially support the vibrating body.

In another configuration, the locking means also can include a housing at which the opening is formed directly. The opening for example can be formed by one or more molded parts which are arranged at walls of the housing, wherein the molded parts define the opening and are rigidly arranged at the housing.

By using a housing, the locking means can be designed as a largely modular construction unit which for example can be attached to the bearing bracket or another component, in that it is clipped to the bearing bracket or the other component.

The actuating element for example can be pivotable about a swivel axis and be coupled with the handle part via a coupling rod such that when adjusting the handle part, the actuating element is pivoted about its swivel axis. In this case, a compensating mass element advantageously additionally is connected with the actuating element, wherein the compensating mass element is formed and provided to counteract an adjustment due to inertial forces in the case of a crash.

The compensating mass element advantageously is adjusted such that forces of inertia, which act on the handle part along the adjusting direction, are absorbed. An actuation of the handle part due to inertial forces in the case of a crash thus is made even more difficult, because as securing systems the compensating mass element on the one hand and the securing device using the mass element and the locking element on the other hand are acting and thus provide a redundant protection against an inadvertent actuation of the closing device in the case of a crash.

The object furthermore is solved by a method for actuating a closing device of a vehicle by using an actuating device of the type described above. In such a method it is provided that the mass element is arranged at a transmission means connected with the actuating element, which on adjusting of the handle part is moved together with the actuating element, and
in a normal operating state during a movement of the actuating element a mass element and a locking means of a securing device operatively connected with the actuating element are moved relative to each other along an adjusting direction, and
in an exceptionally loaded state, in which the mass element and the locking means are shifted relative to each other in a direction transverse to the adjusting direction, a relative movement of the mass element and the locking means along the adjusting direction is blocked such that the actuating element is not movable for actuating the closing device.

With respect to advantages and advantageous aspects of such a method reference is made to what has been described above.

### BRIEF DESCRIPTION OF THE DRAWINGS

The idea underlying the invention will be explained in detail below with reference to the exemplary embodiments illustrated in the Figures, in which:

FIG. 1 shows a schematic view of a vehicle door.

FIG. 2 shows a schematic view of an actuating device in the form of a door handle at a vehicle door.

FIG. 3 shows a view of a concrete configuration of an actuating device in the form of a door handle.

FIG. 4 shows an enlarged view of a securing device of the actuating device.

FIG. 5 shows another view of the securing device.

FIG. 6 shows a view of a modified configuration of a securing device.

FIGS. 7A-7C show different views of a housing of the securing device of FIG. 6.

FIG. 8 shows a view of another exemplary embodiment of a securing device.

FIG. 9 shows a view of the securing device of FIG. 8 with open housing.

FIG. 10 shows a view again of another configuration of a securing device.

FIG. 11 shows another view of the securing device of FIG. 10.

FIG. 12 shows a view again of another configuration of a securing device.

FIG. 13 shows another view of the securing device of FIG. 12.

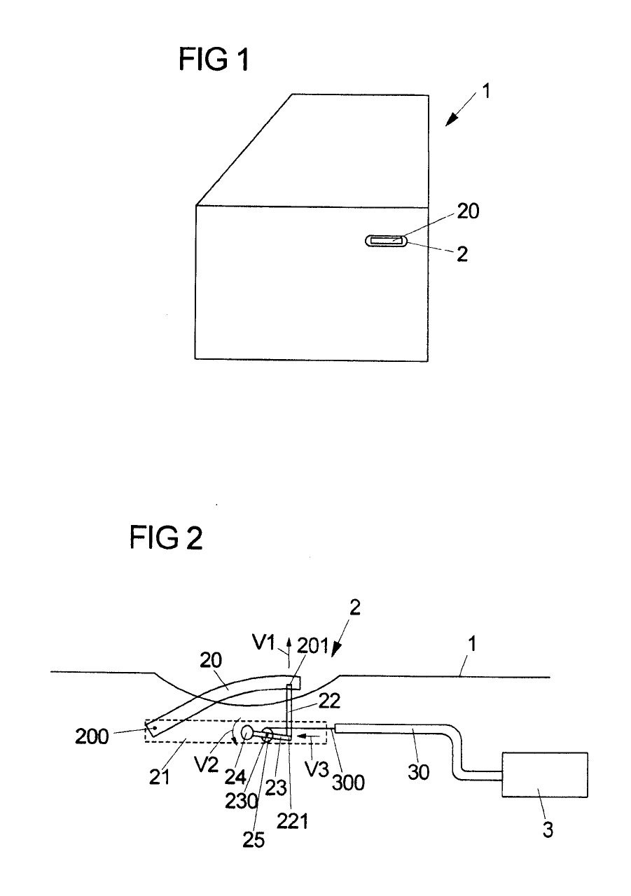

FIG. 1 shows a schematic view of a vehicle door 1, which in a manner known per se includes a door handle 2 with an adjustable handle part 20 which can be actuated for opening the vehicle door 1.

As shown schematically in FIG. 2, a handle part 20 of this type for example can be pivotally arranged at the vehicle door 1 about a swivel axis 200 and via a coupling rod 22 connected with the handle part 20 at a connecting point 201 be coupled with a lever element 23 via an articulation point 221. The lever element 23 is pivotally arranged at a bearing bracket 21 about a swivel axis 230 and is firmly connected with an actuating element 25 which acts on a pulling means 300 of a Bowden 30 for connection with a closing device 3 in the form of a door lock of the vehicle door 1.

The lever element 23 is pivotally arranged at the bearing bracket 21 about the swivel axis 230 and can be moved by adjusting the door handle 20 such that the actuating element 24 exerts an actuating force on the pulling means 300 and thereby actuates the closing device 3 for opening the vehicle door 1. When the handle part 20 correspondingly is adjusted in an opening direction V1, the lever element 23 is pivoted in an adjusting device V2 together with the actuating element 25 and the pulling means 300 thereby is pulled in an adjusting direction V3, so that via the pulling means 300 an actuating force is transmitted to the closing device 3 and the closing device 3 is actuated.

A fundamental prerequisite for a door handle 2 of the type schematically shown in FIGS. 1 and 2 consists in that in the case of a crash an inadvertent actuation of the door handle 2 must not occur, which might lead to an unlocking of the closing device 3 and to the opening of the vehicle door 1. For this purpose, it should be provided in particular that due to inertial forces acting during a side crash the handle part 20 cannot automatically and inadvertently be adjusting in the opening direction V1, because this otherwise might lead to an actuation of the actuating element 25 and to an unlocking of the closing device 3.

To counteract such inertial forces, a compensating mass element 24 is provided as a first securing measure in the arrangement schematically shown in FIG. 2, which is arranged at an end of the lever element 23 facing away from the articulation point 221, so that the articulation point 221 and the compensating mass element 24—based on the swivel axis 230 of the lever element 23—are arranged at different ends of the lever element 23. The compensating mass element 24 serves to counteract inertial forces, which act on the lever element 23 during a side crash and produce a torque in direction of an opening of the handle part 20, by producing an opposite torque which compensates or even overcompensates a torque occurring due to inertial forces, so that the handle part 20 is not adjusted automatically.

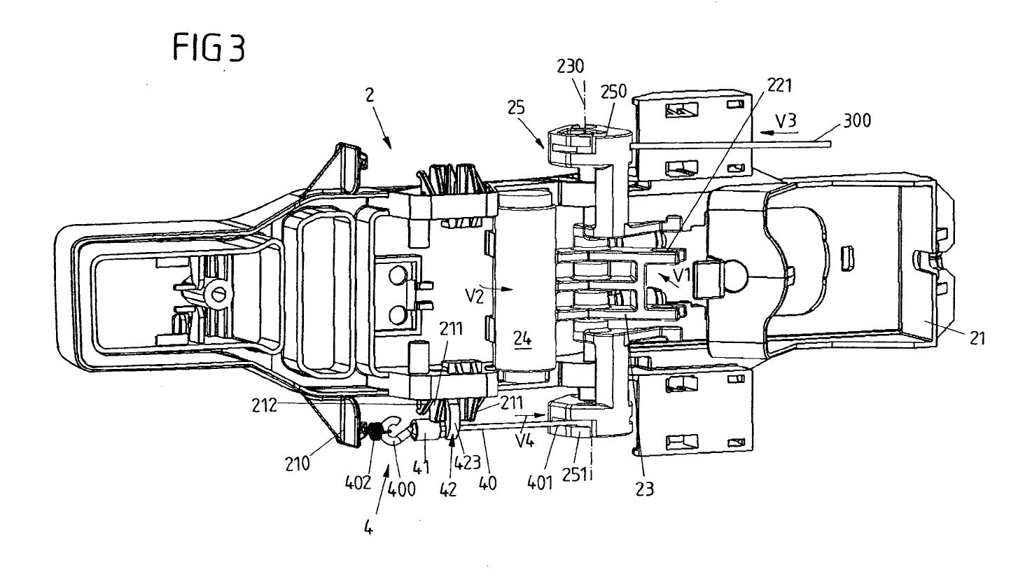

In a concrete configuration of a door handle 3 as shown in FIG. 3, analogous to the exemplary embodiment schematically shown in FIG. 2, a lever element 23 is pivotally arranged at a bearing bracket 21 about a swivel axis 230, wherein the lever element 23 is integrally formed with an actuating element 25 for coupling with a pulling means 300. Via an articulation point 221 at its one end, the lever element 23 is to be connected with a handle part 20 (not shown in FIG. 3) and at its other end carries a mass compensation element 24 which—based on the swivel axis 230—is located opposite the articulation point 221.

The mode of operation of the arrangement according to FIG. 3 is analogous to the one described above with reference to FIG. 2. When the lever element 23 is pivoted via a handle part in an opening direction V1 about the swivel axis 230, the actuating element 25 moves in the adjusting direction V2 about the swivel axis 230 and pulls the pulling means 300 in the adjusting direction V3, so that a closing device coupled with the pulling means 300 is actuated.

In the configuration of FIG. 3, the actuating element 25 is formed by coupling elements 250, 251 which are integrally formed with the lever element 23 and thus are pivotable about the swivel axis 230 together with the lever element 23. The pulling means 300 is connected with the one coupling element 250, while the other coupling element 251 is engaged by an additional securing device 4 which provides an additional protection against an inadvertent adjustment of the actuating element 25 in the case of a crash.

In the exemplary embodiment shown in FIG. 3, the additional securing device 4 comprises a mass element 41 at a transmission means 40 in the form of a pulling cable and a locking means 42 in the form of a vibrating body 423, which is pivotally arranged on the bearing bracket 21, as essential components.

With its one end 400, which is formed as hook, the transmission means 40 in the form of the pulling cable is attached to a fastening portion 210 of the bearing bracket 21 via a spring element 402 and via its other end 401 engages the coupling element 251 of the actuating element 25, so that the transmission means 40 is mounted between the fastening portion 210 of the bearing bracket 21 and the coupling element 251 of the actuating element 25.

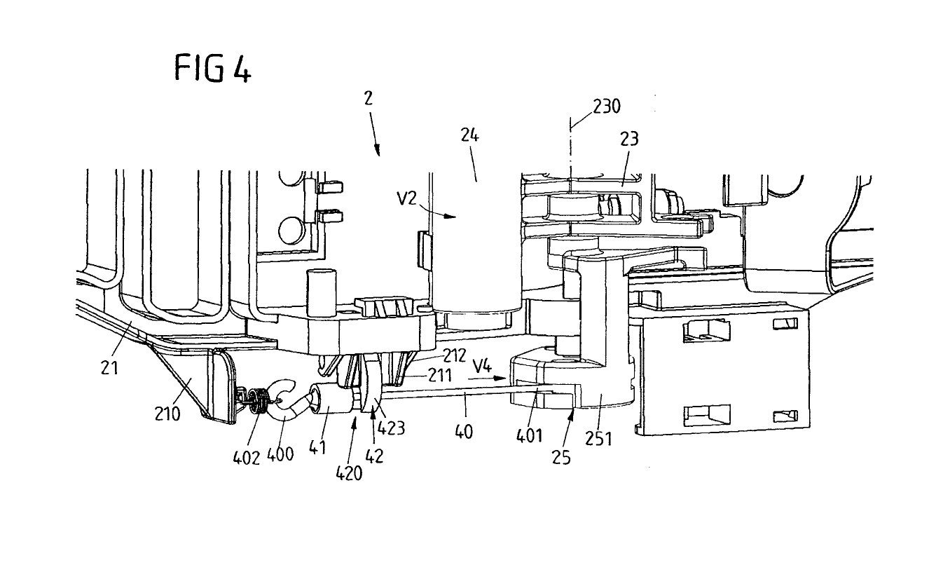

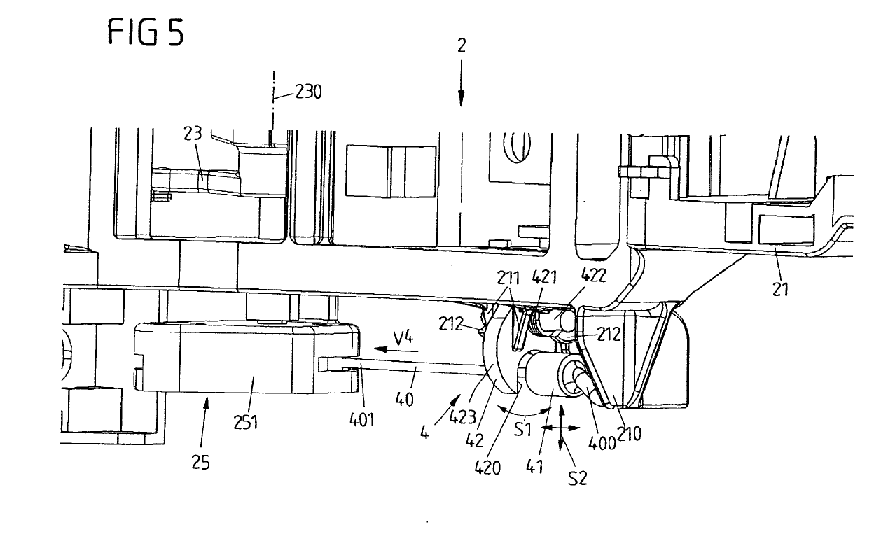

The vibrating body 423, as can be taken from the enlarged representations of FIGS. 4 and 5, is pivotally held in latching elements 212 at the bearing bracket 21 with an axle element 422 and is arranged at the bearing bracket 21 between support portions 211 in the form of protrusions such that the vibrating body 423 is pivotable about the axle element 422 in a swivel direction 51.

The vibrating body 423 has a U-shaped and downwardly open opening 420, through which the transmission means 40 extends and which has a clear width which is (slightly) larger than the diameter of the mass element 41.

The securing device 4 serves for blocking an actuation of the actuating element 25 in the case of a crash, but without impairing the actuation of the actuating element 25 in a normal operating state, in which no crash forces are acting.

The mode of operation of the securing device 4 is as follows.

In a normal operating state the transmission means 40 extends through the opening 420 of the vibrating body 423 such that during an actuation of the actuating element 25 for opening the closing device 3 (due to which the coupling element 251 is pivoted in the adjusting direction V2 according to FIG. 4) the transmission means 40 is approximately linearly adjusted in an adjusting direction V4 and the mass element 41 is moved through the opening 420. In the normal operating state, the vibrating body 423 is held in a rest position, caused by a spring element 421 arranged at the axle element 422, which elastically biases the vibrating body 423 with respect to the bearing bracket 21.

In a normal operating state, the actuation element 25 thus can easily be moved without this being prevented by the securing device 4.

In the case of a crash, however, a deflection of the mass element 41 and/or the vibrating body 423 occurs due to the forces acting in a crash. The mass element 41 can move in all directions in space transversely to the adjusting direction V4 (corresponding to the directions of movement S2 according to FIG. 5), while the vibrating body 423 can perform a movement along the direction of movement 51 about the axle element 422 transversely to the adjusting direction V4. When an impact occurs in the case of a crash and correspondingly inertial forces occur at the mass element 41 and the vibrating body 423, a deflection of the mass element 41 and/or the vibrating body 423 occurs (at least always when the inertial forces do not act exactly along the adjusting direction V4), so that the vibrating body 423 and the mass element 41 are shifted relative to each other and during an actuation of the actuating element 25 the mass element 41 cannot (no longer) be guided through the opening 420, because the mass element 41 strikes against the vibrating body 423.

To prevent that the mass element 41 and the vibrating body 423 are deflected in exactly the same way, the masses of the mass element 41 and of the vibrating body 423 as well as also the spring bias of the spring element 402 (for biasing the transmission means 40) and of the spring element 421 (for biasing the vibrating body 423) can suitably be adjusted such that in the case of a crash the deflection is effected differently.

As shown in FIG. 3, the transmission means 40 extends in approximately the same direction as the pulling means 300 extending from the coupling element 250 and vertically to the opening direction V1, in which the handle part 20 is to be moved for actuating the door lock 3. The securing device 4 thus blocks in particular during a side crash (with an impact direction along the opening direction V1), but also with other impact directions which at least with one directional component are directed transversely to the adjusting direction V4 of the pulling means 40 and thus lead to an inertia-related deflection of the mass element 41 and/or the vibrating body 423.

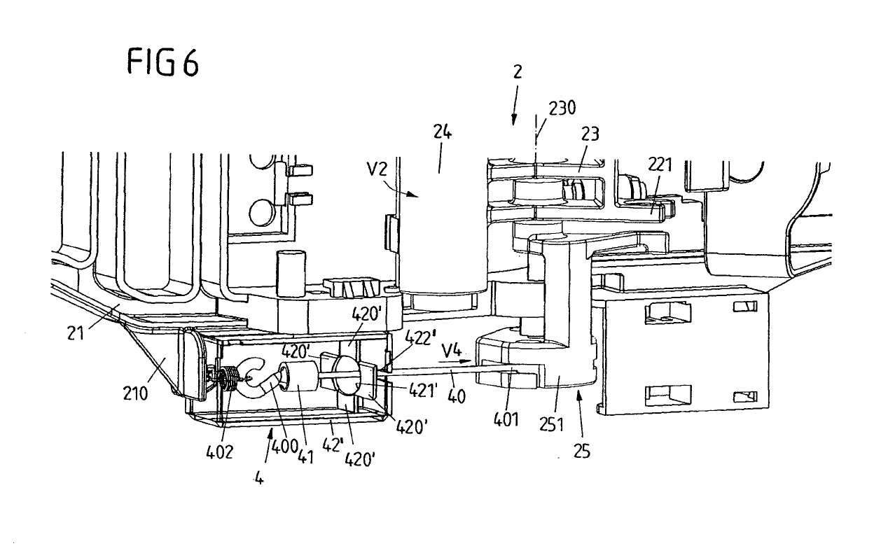

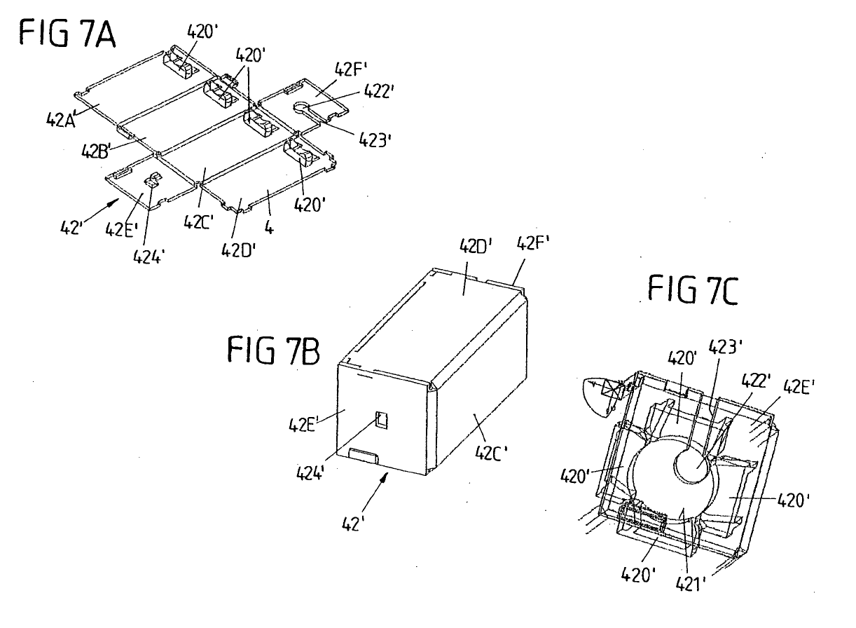

FIGS. 6 and 7A-7C show another exemplary embodiment of a securing device 4, in which a securing device 4 is provided with a modified locking means 42′.

The locking means 42′ includes a housing which is formed with six walls 42A′-42F′ connected with each other via film hinges and at the insides of the four longitudinally extending walls 42A′-42D′ carries molded parts 420′ which together form an opening 421′.

In a normal operating state of the actuating device 2, the mass element 41 can be moved along the adjusting direction V4 through the opening 421′ upon actuation of the actuating element 25, so that an actuation of the actuating element 25 is not impaired or even blocked. But when in the case of a crash, analogous to what has been described above, the mass element 41 is deflected relative to the opening 421′ in a direction in space transversely to the adjusting direction V4, the mass element 41 strikes against one or more of the molded parts 420′ in the case of an attempted actuation of the actuating element 25, so that a movement of the mass element 41 and accordingly of the transmission means 40 in the adjusting direction V4 is prevented and hence an actuation of the actuating element 25 is blocked.

On the end face of the housing formed by the walls 42A′-42F′ a through opening 424′ for attaching the transmission means 40 by means of the spring element 402 to the fastening portion 210 of the bearing bracket 21 (wall 42E′) and a slot 423′ as well as an opening 422′ for introducing the transmission means 40 are arranged (wall 42F′).

By providing the box-shaped housing a modular unit can be created, which in a modular way is attached to the bearing bracket 21 and can be clipped for example to the bearing bracket 21.

In the exemplary embodiments of FIGS. 3-5 and FIGS. 6, 7A-7C an additional transmission means 40 is provided, which is connected with the actuating element 25 separate from the transmission means 300 and is mounted between the actuating element 25 and the bearing bracket 21.

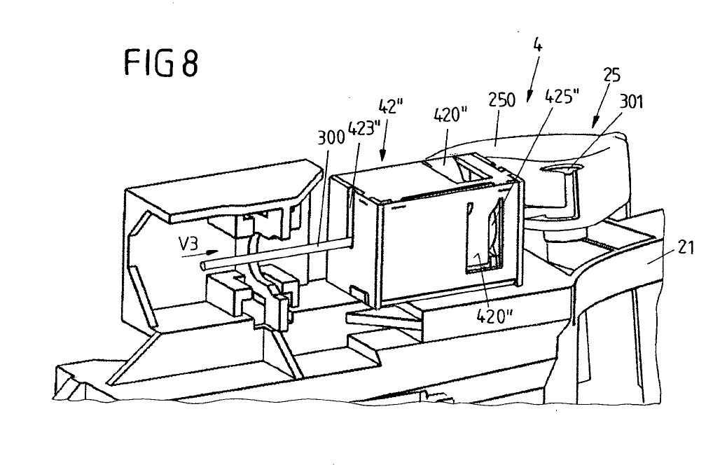

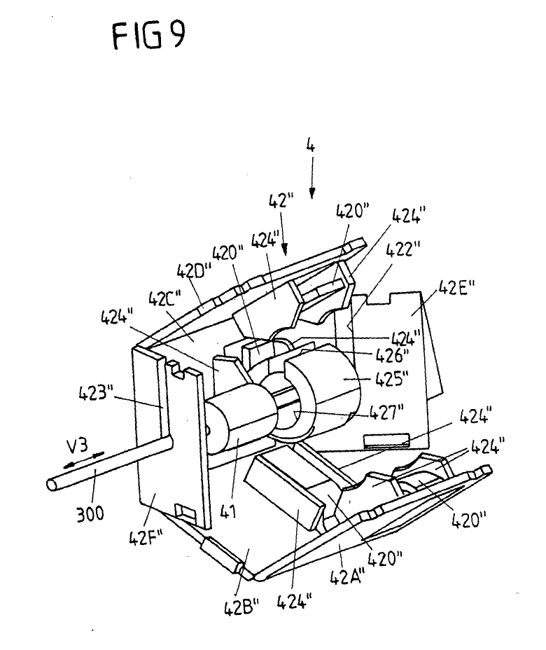

In an exemplary embodiment shown in FIGS. 8 and 9, a securing device 4 is arranged at the transmission means 300 for connecting the actuating element 25 with the closing device 3, which includes a housing formed by walls 42A″-42F″, which via spring elements 420″ integrally molded to the longitudinally extending walls 42A″-42B″ carries a vibrating body 425″ which circumferentially encloses the transmission means 300.

The mode of operation of the securing device 4 according to the exemplary embodiment of FIGS. 8 and 9 is analogous to what has been described above. In a normal operating state, a mass element 41 arranged at the transmission means 300 can be moved in the adjusting direction V3, along which the transmission means 300 is linearly moved when actuating the actuating element 25, through an opening 427″ of the vibrating body 425″, so that an actuation of the actuating element 25 is not impaired. However, when in the case of a crash the mass element 41 and/or the vibrating body 425″ are deflected transversely to the adjusting direction V3, a movement of the mass element 41 through the opening 427″ of the vibrating body 425″ is not possible, so that the securing device 4 blocks a movement of the pulling means 300 and correspondingly prevents an actuation of the actuating element 25.

The mass element 41 arranged at the transmission means 300 acts directly in direction of the flux of force of the pulling means 300 and hence directly blocks the flux of force for actuating the closing device 3.

Analogous to what has been described above with reference to the exemplary embodiment of FIGS. 3-5, the spring elements 420″, the tension of the transmission means 300 and the masses of the mass element 41 and the vibrating body 425″ are to be adjusted such that in the case of a crash the deflection of the mass element 41 and the vibrating body 425″ is not effected in the same way and thus in the case of a crash a relative movement occurs between the mass element 41 and the vibrating body 425″ transversely to the adjusting direction V3.

As shown in FIG. 9, axial securing elements 424″ additionally are provided at the longitudinally extending walls 42A″-42D″ on both sides of the vibrating body 425″, which axially fix the vibrating body 425″ along the adjusting direction V3 at the housing formed by the walls 42A″-42F″, so that the vibrating body 425″ can move in the housing exclusively in a plane transverse to the adjusting direction V3.

As is also shown in FIG. 9, slots 422″, 423″ each are provided at the end-face walls 42E″, 42F″, through which the transmission means 300 can reach and which provide for an attachment of the housing to the transmission means 300.

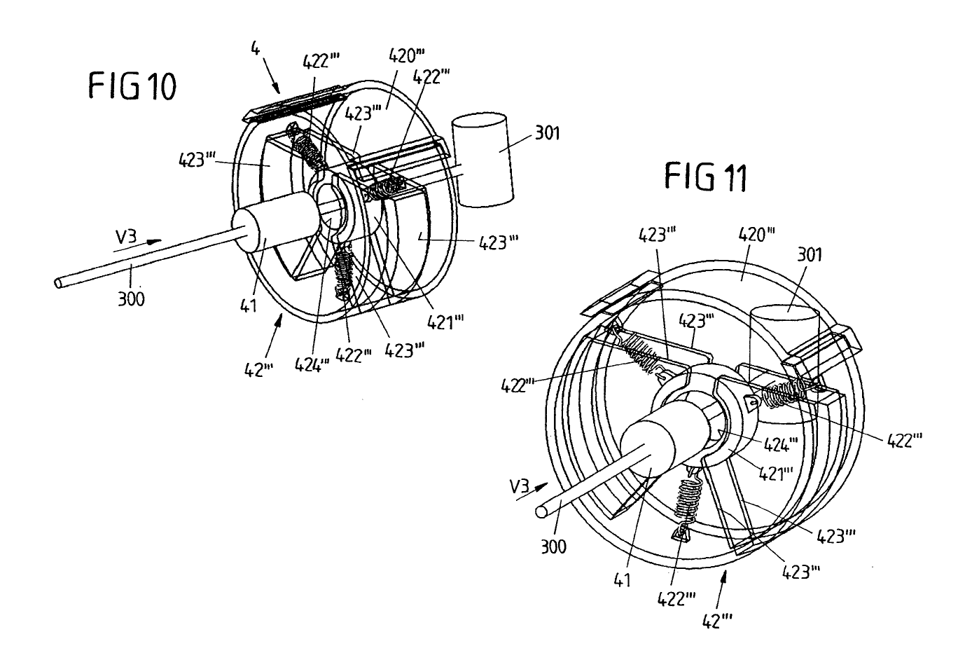

In a further exemplary embodiment shown in FIGS. 10 and 11, there is used a locking means 42′″ with a housing 420′ circular in cross-section transversely to the adjusting direction V3, which via three spring elements 422′″ offset to each other by 120° in circumferential direction carries a vibrating body 421′″ with a central opening 424′. The vibrating body 421′″ is axially fixed via axial securing elements 423′″ and thus is movable exclusively in a plane transverse to the adjusting direction V3.

Analogous to the exemplary embodiment of FIGS. 8 and 9 it is also in the exemplary embodiment of FIGS. 10 and 11 that a mass element 41 is arranged at the transmission means 300 which connects the actuating element 25 with the closing device 3. What is also shown in FIGS. 10 and 11 is a rope nipple 301 with which the transmission means 300 (formed as pulling means of a Bowden cable) is to be connected with the coupling element 250 of the actuating element 25 for transmitting pulling forces.

The mode of operation of the securing device 4 according to FIGS. 10 and 11 is analogous to what has been described above, so that reference should be made to the above explanations.

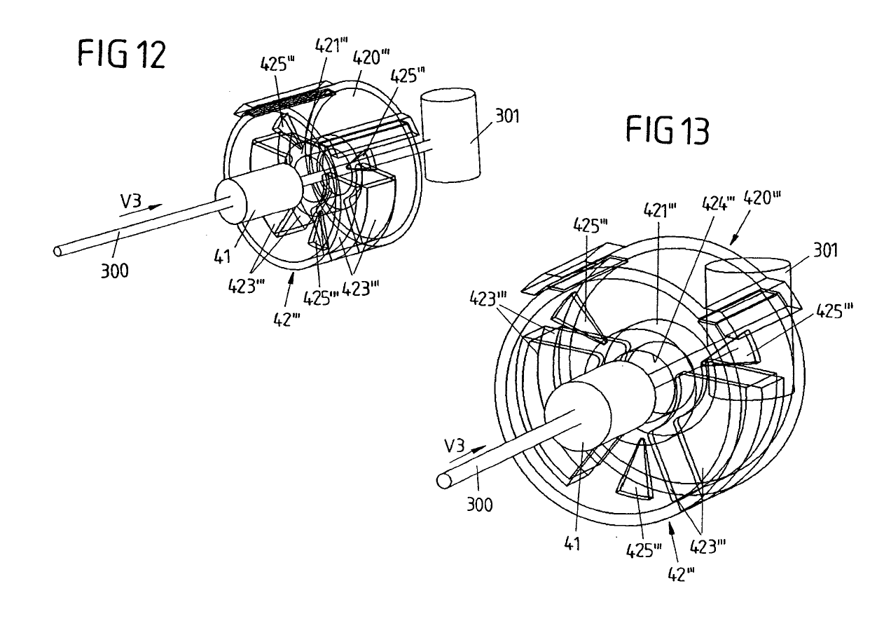

FIGS. 12 and 13 show an exemplary embodiment modified only slightly as compared to the exemplary embodiment of FIGS. 10 and 11, which differs from the exemplary embodiment of FIGS. 10 and 11 in that the vibrating body 423′″ is held at the housing 420″ not via spring elements, but by molded parts 425′″ integrally molded to the housing 420′″. The molded parts 425′″ have a triangular shape and are arranged on the inside of the housing 420″ offset to each other by 120° in circumferential direction. The molded parts 425′″ rigidly connect the vibrating body 421′″ with the housing 420′″, so that in the case of a crash merely the mass element 41, but not the vibrating body 421′″ can be deflected.

In the exemplary embodiment of FIGS. 12 and 13, the housing 420′″ can be manufactured in one piece together with the molded parts 425″, the axial securing elements 423′″ and the vibrating body 421′″ in one operation by injection molding, for example by using the 2-component technology. The vibrating body 421′″ thus is manufactured already in its proper position in the housing 420′″, so that additional mounting steps for attaching the vibrating body 421″ can be omitted.

In addition, predetermined breaking points can be provided between the molded parts 425′″ and the vibrating body 421′″, which will break in the case of a crash, so that the vibrating body 421′″ is radially movable and is axially supported via the axial securing elements 423′.

Alternatively or in addition, the axial securing elements 423′″ also can include predetermined breaking points, so that after a crash upon application of a sufficiently large actuating force a destruction of the molded parts 425′ and/or the axial securing elements 423′″ can occur, in order to provide for an opening of the vehicle door 1.

The idea underlying the invention is not limited to the exemplary embodiments described above, but can also be realized in completely different embodiments.

In particular, the use of a securing device of the type described above is not limited to door handles, but can also be used in other actuating devices.

In principle, other mounting and suspension possibilities of a mass element and a locking means with or without vibrating body are conceivable, which ensure a safe blocking of an actuation in the case of a crash, but at the same time do not impair an actuation during a normal operating state.

1-29. (canceled)

30. An actuating device for actuating a closing device of a vehicle, comprising
an adjustable handle part,
an actuating element coupled with the handle part, which is movable by adjusting the handle part for actuating the closing device, and
a securing device operatively connected with the actuating element which includes a mass element and a locking means, wherein the mass element is arranged at a transmission means connected with the actuating element, which is moved when adjusting the handle part together with the actuating element, and
in a normal operating state during a movement of the actuating element the mass element and the locking means are movable relative to each other along an adjusting direction, and
in an exceptionally loaded state, in which the mass element and the locking means are shifted relative to each other in a direction transversely to the adjusting direction, a relative movement of the mass element and the locking means along the adjusting direction is blocked such that the actuating element is not movable for actuating the closing device.

31. The actuating device according to claim 30, wherein the actuating device includes a bearing bracket at which the handle part and the actuating element are arranged.

32. The actuating device according to claim 31, wherein the securing device is arranged at the bearing bracket.

33. The actuating device according to claim 30, wherein the securing device is arranged at the closing device or in a power transmission train between the closing device and the actuating device.

34. The actuating device according to claim 30, wherein the locking means forms an opening which in the normal operating state is arranged relative to the mass element such that the mass element is movable through the opening, in order to adjust the mass element and the locking means relative to each other along the adjusting direction.

35. The actuating device according to claim 34, wherein the opening of the locking means is formed at a vibrating body of the locking means.

36. The actuating device according to claim 35, wherein the vibrating body is pivotable in a plane transverse to the adjusting direction.

37. The actuating device according to claim 36, wherein the vibrating body is pivotally mounted via an axle element.

38. The actuating device according to claim 37, wherein the vibrating body and the mass element are formed and mounted such that in the exceptionally loaded state the vibrating body and the mass element are deflected differently, so that a relative movement of the mass element and the vibrating body is blocked along the adjusting direction.

39. The actuating device according to claim 38, wherein the vibrating body and the mass element have different masses.

40. The actuating device according to claim 35, wherein the locking means includes a housing at which the vibrating body forming the opening is held.

41. The actuating device according to claim 40, wherein the vibrating body is elastically held at the housing such that the vibrating body is deflectable in a plane transverse to the adjusting direction.

42. The actuating device according to claim 40, wherein the vibrating body is held at the housing via at least one spring element.

43. The actuating device according to claim 40, wherein the vibrating body is held at the housing via at least three spring elements in a plane transverse to the adjusting direction.

44. The actuating device according to claim 40, wherein the vibrating body is held at the housing via at least one molded part.

45. The actuating device according to claim 44, wherein the at least one molded part has a predetermined breaking point which is designed such that by breaking the at least one molded part the vibrating body can be removed from the housing.

46. The actuating device according to claim 40, wherein at the housing at least one axial securing element is arranged for supporting the vibrating body against being shifted along the adjusting direction relative to the housing.

47. The actuating device according to claim 39, wherein the locking means includes a housing at which the opening is formed.

48. The actuating device according to claim 31, wherein the locking means includes a housing at which the vibrating body forming the opening is held and the housing is attached to the bearing bracket.

49. A method for actuating a closing device of a vehicle, by using an actuating device which includes
an adjustable handle part, and
an actuating element coupled with the handle part, which is movable by adjusting the handle part for actuating the closing device,
wherein the mass element is arranged at a transmission means connected with the actuating element, which on adjusting the handle part is moved together with the actuating element, and
in a normal operating state during a movement of the actuating element a mass element and a locking means of a securing device operatively connected with the actuating element are moved relative to each other along an adjusting direction, and
in an exceptionally loaded state, in which the mass element and the locking means are shifted relative to each other in a direction transversely to the adjusting direction, a relative movement of the mass element and the locking means along the adjusting direction is blocked such that the actuating element is not movable for actuating the closing device.
